(19) United States
(12) Patent Application Publication
(10) Pub. No.: US 2010/0242453 A1
(43) Pub. Date: Sep. 30, 2010

(54) Fuel cell/engine hybrid power system

(76) Inventors: Darrin A. Johnston, Washington, IL (US); Brian D. Terrell, Dunlap, IL (US); John C. Lauper, JR., East Peoria, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/443,414

(22) Filed: May 31, 2006

(51) Int. Cl. F01N 3/10; F02B 43/00; F02M 25/12; H01M 8/06

(52) U.S. Cl. 60/301; 123/3; 60/299; 429/416

(57) ABSTRACT

A power system has an energy conversion device and a volume expansion engine. The energy conversion device is configured to receive fuel, implement an electro-chemical process to generate an electrical output, and produce a first exhaust flow. The volume expansion engine is configured to receive the first exhaust flow, combust the first exhaust flow to generate a power output, and produce a second exhaust flow directed into the energy conversion device.

### TECHNICAL FIELD

The present disclosure is directed to a power system and, more particularly, to a fuel cell/engine hybrid power system.

### BACKGROUND

Fuel cell power systems employ electro-chemical energy conversion devices known as fuel cells that catalyze a reaction between a fuel and an oxidizer to directly produce electricity. Specifically, air and a fuel such as, for example, hydrogen or methane, are directed into cathode (positive) and anode (negative) flow paths of the fuel cells. A typical fuel cell consists of an electrolyte layer in contact with the anode and the cathode on either side. Fuel is fed to the anode while an oxidant is fed to the cathode. An electrochemical process occurs that produces en electric current through the electrolyte, while driving a complementary electric current through an external circuit. The exhaust from the fuel cell (e.g., the water molecules, carbon dioxide molecules, nitrogen molecules, and any unused fuel) is then emitted to the environment.

Although fuel cell power systems have been found to be efficient and low producers of harmful pollution, their efficiency may be improved when combined with a combustion engine. In particular, the exhaust exiting a fuel cell power system can contain enough unused fuel to power a combustion engine and produce additional useful energy. One such system that integrates fuel cell technology with a combustion engine in a single power system application is described in U.S. Pat. No. 6,606,850 (the '850 patent) issued to Logvinov et al. Aug. 19, 2003. The '850 patent describes a hybrid fuel cell volume expansion engine supplied with a raw hydrocarbon fuel and air. The fuel is directed through a heat exchanger to a reformer, where it is mixed with exhaust from a fuel cell, heated, and subsequently converted into a mixture containing hydrogen and carbon monoxide. The mixture is then directed into the fuel cell, along with the supply of air, where an electro-chemical reaction produces electricity. The outlet of the fuel cell, in addition to being fluidly connected to the reformer, is also connected to an internal combustion engine to feed the engine with remnants of the reformed fuel and air. The engine combusts the remnants to drive an electric generator. Heat from the engine is directed to the reformer to facilitate the mixing process described above. To increase the power output of the engine, extra fuel and air may be supplied to the engine.

Although the hybrid fuel cell volume expansion engine of the '850 patent may have improved efficiency over a fuel cell only power system, it may be expensive and limited. In particular, because the hybrid engine of the '850 patent requires a heat exchanger to transfer heat from the internal combustion engine to the reformer, the cost of the hybrid engine may be significant. In addition, because the hybrid engine of the '850 patent does not include a supply of carbon-dioxide directed into the fuel cell, certain types of fuel cells such as, for example, Molten Carbonate Fuel Cells (MCFCs), may be incompatible with the hybrid engine.

The power system of the present disclosure solves one or more of the problems set forth above.

### SUMMARY OF THE INVENTION

One aspect of the present disclosure is directed to a power system. The power system includes an energy conversion device and a volume expansion engine. The energy conversion device is configured to receive fuel, implement an electro-chemical process to generate an electrical output, and produce a first exhaust flow. The volume expansion engine is configured to receive the first exhaust flow, combust the first exhaust flow to generate a power output, and produce a second exhaust flow directed into the energy conversion device.

Another aspect of the present disclosure is directed to a method of producing power. The method includes initiating an electro-chemical process involving fuel and a first flow of exhaust to generate an electrical output and a second flow of exhaust. The method also includes combusting the second flow of exhaust to produce a power output and the first flow of exhaust.

### BRIEF DESCRIPTION OF THE DRAWINGS

FIG. 1 is a diagrammatic illustration of an exemplary disclosed power system.

### DETAILED DESCRIPTION

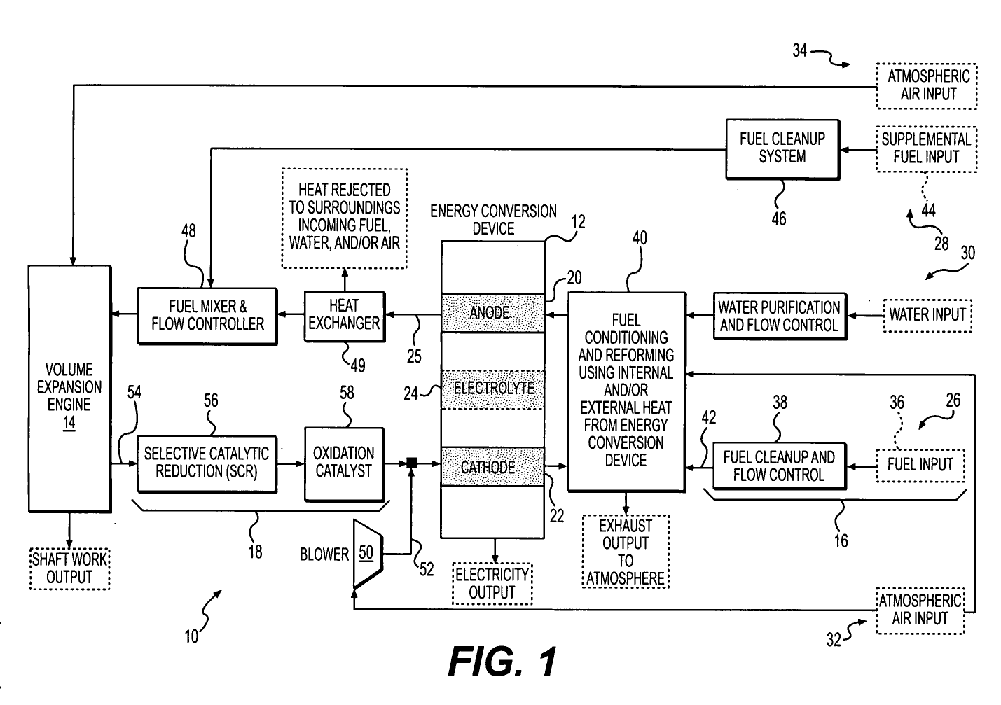

FIG. 1 illustrates a power system 10 having an energy conversion device 12 fluidly coupled to a volume expansion engine 14. Power system 10 may embody a primary power plant configured to produce and supply continuous power to internal and/or external customers, a backup power system configured to supply power in situations of primary supply failure, the primary mover in a mobile application, or any other similar power generating system. Power system 10 may include a supply system 16 configured to supply fuel, air, and water to energy conversion device 12 and volume expansion engine 14, and an exhaust treatment system 18 configured to direct various flows of exhaust throughout power system 10.

Energy conversion device 12 may generate DC electricity by using fuel cell technology. Specifically, energy conversion device 12 may embody one or more fuel cell stacks such as, for example, a Phosphoric-Acid Fuel Cell (PAFC) stack, Solid Oxide Fuel Cell (SOFC) stack, or a Molten Carbonate Fuel Cell (MCFC) stack. Each fuel cell within energy conversion device 12 may include, among other things, an anode 20, a cathode 22, and an electrolyte 24 that interact to perform an electro-chemical process that generates electricity.

Anode 20 may be the negative element of energy conversion device 12, and perform multiple functions. First, anode 20 may help disperse gaseous fuel supplied to energy conversion device 12 substantially equally over the surface of electrolyte 24. As the fuel flows into anode 20, the gas may be forced through a catalyst disposed on the surface of electrolyte 24, causing an electrochemical reaction that produces or consumes ions transmitted through electrolyte 24. The electrochemical reaction also produces free electrons. Second, anode 20 may conduct electrons freed from the electrochemical process through an external circuit (not shown) to perform useful work. An exhaust containing some unused fuel may be directed from anode 20 by way of an exhaust passageway 25.

Cathode 22 may be the positive element of energy conversion device 12, and likewise perform multiple functions. First, cathode 22 may help disperse air (and carbon dioxide in the case of an MCFC) supplied to energy conversion device 12 substantially equally over the surface of electrolyte 24. As the air flows into cathode 22, it may be forced through the catalyst, causing an electrochemical reaction, which either produces or consumes ions transmitted through electrolyte 24. Second, cathode 22 may return the freed electrons from the external circuit to the cathode side of energy conversion device 12. The electrochemical reaction at cathode 22 may consume the freed electrons.

Electrolyte 24 may consist of a membrane material having a chemically treated surface. In the example of an MCFC stack, the membrane may be treated with a molten carbonate substance. Electrolyte 24 may be configured to conduct only positively charged ions (e.g., the freed electrons may be blocked from passing through electrolyte 24).

Volume expansion engine 14 may combust a mixture of fuel, air, and anode exhaust gas to produce a corresponding mechanical power output and a flow of exhaust. In one example, volume expansion engine 14 may embody an internal combustion engine such as, for example, a diesel engine, a gasoline engine, or a gaseous fuel-powered engine. The engine may include a combustion chamber (not shown) having a piston (not shown) disposed therein and being operatively connected to a crankshaft (not shown). As the fuel/air/exhaust mixture is combusted, the piston may be forced to reciprocate, thereby rotating the crankshaft and producing a mechanical power output. The crankshaft may be associated with, for example, a generator (not shown) such that the mechanical power output may be converted to an electrical power output, if desired. It is contemplated that volume expansion engine 14 may alternatively embody a gas turbine engine or any other suitable type of combustion engine.

Supply system 16 may include components that deliver fuel, water, and air to energy conversion device 12 and volume expansion engine 14. In particular, supply system 16 may include a primary fuel supply system 26, a supplemental fuel supply system 28, a water supply system 30, a primary air supply system 32, and a supplemental air supply system 34.

Primary fuel supply system 26 may include a tank (not shown) configured to hold a supply of fuel, and a fuel pumping arrangement 36 configured to pressurize the fuel. The pressurized fuel may be directed by way of a fuel line 42 through a cleaning and control mechanism 38, and a reformer 40 to each fuel cell within energy conversion device 12. The supply of fuel may include an ammonia, alcohol, or hydrocarbon fuel such as, for example, hydrogen, methane, ethane, propane, butane, gasoline, kerosene, diesel, miliarly fuels and oils, carbon monoxide, and gasified coal or biomass. Fuel pumping arrangement 36 may include a single pumping device or multiple devices disposed in series relationship. It is contemplated that a natural expansion of the fuel supplied to energy conversion device 12 may perform the required pumping action and that fuel pumping arrangement 36 may be omitted, if desired.

Cleaning and control mechanism 38 may remove unwanted constituents from the fuel supplied to energy conversion device 12, and regulate the flow thereof. For example, cleaning and control mechanism 38 may include adsorbent and/or absorbent materials such as activated carbon or zeolite that removes sulfur compounds from gaseous fuels, and/or filtration media that remove solid particulates. Flow meters and electronic valves in communication with a central controller (not shown) may be included within cleaning and control mechanism 38 to regulate the flow of purified fuel in response to one or more input.

Reformer 40 may provide fuel mixing and conversion functions. In particular, as raw fuel and water flow into reformer 40, the two flows may heated by way of one or more heat exchangers (not shown), and mixed in the presence of a catalyst (not shown) to form a stream of hydrogen and carbon monoxide. This method of reforming is known as steam reforming and may account for part or all of the fuel conversion that occurs within power system 10. The remaining fuel conversion may be accomplished through the use of catalysts located within energy conversion device 12. It is contemplated that other conversion processes such as partial oxidation reforming or autothermal reforming may alternatively or additionally be implemented prior to induction of the fuel mixture into energy conversion device 12, if desired. If implemented, the partial oxidation or autothermal reforming may require an input of oxygen or air from primary or supplement air supply systems 32, 34.

Supplemental fuel supply system 28 may include a tank (not shown) configured to hold a supply of fuel, a fuel pumping arrangement 44 configured to pressurize the fuel and direct the pressurized fuel through a fuel cleanup system 46 to volume expansion engine 14. The supply of fuel directed through supplemental fuel supply system 28 may include any combination of the hydrocarbon fuels listed above. As the fuel flows through fuel cleanup system 46, unwanted contaminants, which may be damaging to volume expansion engine 14 or energy conversion device 12, may be absorbed and/or adsorbed by a material such as carbon or zeolite that removes sulfur compounds from gaseous fuels and/or filtration media that removes sold particulates. The flow of fuel to volume expansion engine 14 may be regulated by way of a mixer and control mechanism 48 such that exhaust emissions from volume expansion engine 14 may remain compliant with emission regulations. It is contemplated that supplemental fuel supply system 28 may be omitted, if desired, and an over-fuelling strategy associated with energy conversion device 12 alternatively or additionally implemented. It is further contemplated that fuel pumping arrangement 36 may alternatively be common to both primary and supplemental fuel supply systems 26 and 28, if desired.

Mixer and control mechanism 48 may be disposed within exhaust passageway 25 to connect supplemental fuel supply system 28 and anode 20 to volume expansion engine 14. Specifically, mixer and control mechanism 48 may embody a spool valve, a shutter valve, a butterfly valve, a check valve, or any other valve known in the art movable to regulate the flow of the fuel and exhaust gas through exhaust passageway 25. Mixer and control mechanism 48 may be electrically actuated, hydraulically actuated, pneumatically actuated, or actuated in any other manner in response to one or more predetermined conditions such that flow rate of fuel and exhaust gas into volume expansion engine 14 results in emission compliant operation of volume expansion engine 14. Mixer and control mechanism 48 may be actuated with any of the aforementioned methods such that the flow rate of exhaust gas through exhaust passageway 25 results in desired operating conditions within energy conversion device 12. A heat exchanger 49 may also be located within exhaust passageway 25 upstream of mixer and control mechanism 48, if desired, to facilitate the rejection of heat from the anode exhaust gas to the atmosphere or to the streams of fuel and water directed through reformer 40 or to the streams of air flowing from primary air supply system 32 or through fluid passageway 52.

Water supply system 30 may provide the water used during the steam reforming process described above. Water supply system 30 may embody a multi-stage water treatment system, including filtration media such as activated carbon elements, a water softener having an associated brine tank, sediment removing elements, a reverse osmosis membrane and associated pumps, an electronic de-ionizer, polishing elements, and any other appropriate water treatment elements. Water supply system 30 may also include the pumps, flow meters, and electrically-controlled valves necessary to regulate the flow rate and/or pressure of water supplied to reformer 40.

Primary air supply system 32 may include a means for introducing charged air into cathode 22 of energy conversion device 12. In one example, primary air supply system 32 may include one or more blowers 50 (only one illustrated in FIG. 1) in communication with cathode 22 by way of a fluid passageway 52. The flow rate of air from blower 50 may be regulated in response to a temperature of cathode 22. It is contemplated that additional and/or different components may be included within primary air supply system 32 such as, for example, one or more air cleaners, a compressor, a pressure control mechanism, and other means known in the art for introducing charged air into cathode 22.

Supplemental air supply system 34 may also embody a charged induction system associated with volume expansion engine 14. For example, supplemental air supply system 34 may include a blower or compressor (not shown) in fluid communication with one or more inlet ports of volume expansion engine 14. In this manner, hot exhaust gases emitted from volume expansion engine 14 may be directed to drive the compressor and thereby force air into volume expansion engine 14 for subsequent combustion. It is contemplated that volume expansion engine 14 may alternatively be naturally aspirated, if desired.

Exhaust treatment system 18 may include a means for directing exhaust flow from volume expansion engine 14. For example, exhaust treatment system 18 may include a fluid passageway 54 connecting the exhaust from volume expansion engine 14 to cathode 22. It is contemplated that exhaust treatment system 18 may also include emission controlling devices such as particulate traps, an SCR device 56, a NOx adsorber, an oxidation catalyst 58, or other catalytic devices, attenuation devices, and other means for directing exhaust flow from volume expansion engine 14 that are known in the art. It is further contemplated that if volume expansion engine 14 employs a charged air induction system, the turbine(s) associated therewith may be disposed within fluid passageway 54 to utilize the energy associated with expansion of hot exhaust gases flowing from volume expansion engine 14. After passing through cathode 22, the exhaust flow may be directed to the heat exchangers of reformer 40, if desired, to transfer heat to the fuel and water mixture therein, before being released to the atmosphere.

### INDUSTRIAL APPLICABILITY

The power system of the present disclosure has wide application in power generating situations where high efficiency, low exhaust emissions, and design flexibility are desired. Specifically, by directing an exhaust flow from a fuel cell to a combustion engine, normally wasted fuel in the exhaust flow may be utilized to generate additional useful energy. In addition, because the exhaust flow from the fuel cell typically contains hydrogen, carbon monoxide, and other constituents, the engine combusting the fuel cell exhaust may be operated in a low polluting mode. This low polluting mode may be accomplished by operating the engine with an exceptionally lean mixture of fuel and air (e.g., a mixture having a low ratio of fuel to air). combustion of such a mixture may be facilitated by the hydrogen, carbon monoxide, or other constituents present in the exhaust flow from the fuel cell. Further, by directing exhaust from the combustion engine back to the fuel cell, heat and constituents of the engine's exhaust may facilitate economical use of a variety of fuel cell types. The operation of power system 10 will now be explained.

Fuel, water, and air may be supplied to energy conversion device 12 and chemically processed to generate electricity. Specifically, fuel, water, and air may be purified and flow regulated into reformer 40, where a steam reforming process, a partial oxidation process, or an autothermal process may create a partially or fully reformed fuel mixture directed into anode 20 of energy conversion device 12. Substantially simultaneously, air and exhaust from volume expansion engine 14 may be directed into cathode 22 of energy conversion device 12. As described above, the reformed fuel from anode 20 may be dispersed substantially equally over the surface of electrolyte 24 and subsequently forced through a catalyst disposed thereon, causing an electrochemical reaction within cathode 22 that produces or consumes ions transmitted through electrolyte 24. The electrochemical reaction may produce free electrons. After conductance of the free electrons through an external circuit, the electrons may be consumed by an electrochemical reaction, which either frees or consumes ions transmitted through electrolyte 24. Exhaust containing some unused fuel may be directed from anode 20 to volume expansion engine 14 by way of exhaust passageway 25. Exhaust from cathode 22 may be directed through heat exchangers within reformer 40, where it may impart heat to the incoming fuel, water, and air prior to release to the atmosphere. Alternatively, the exhaust from cathode 22 may be vented directly to the atmosphere, if desired.

The exhaust from anode 20 may be directed into and combusted by volume expansion engine 14 to generate a mechanical power output. As the exhaust is directed into volume expansion engine 14, additional fuel may be selectively supplied to volume expansion engine 14 by way of supplemental fuel system 28 to increase the power output thereof during times of peak demand. Additionally or alternatively, the flow of fuel directed into energy conversion device 12 may be increased such that a greater amount of unused fuel is contained within the exhaust from anode 20. The amount of supplemental fuel and/or “over fuelling” may be regulated such that exhaust emissions from power system 10 remain compliant with government regulations. Exhaust from volume expansion engine 14 may be directed through one or more aftertreatment devices before joining the air flow from blower 50 entering cathode 22. Blower 50 may be flow regulated such that the mixture of air and exhaust entering cathode 22 remains below a maximum temperature value accommodated by energy conversion device 12.

At startup of power system 10, the operation of volume expansion engine 14 may be initiated first. In particular, the heat of the exhaust from volume expansion engine 14 in fluid passageway 54 may be used to warm fuel, water, and air that is supplied to energy conversion device 12 and reformer 40 such that a desired predetermined operating temperature is achieved prior to initiating operation of energy conversion device 12. This warming step may improve operation and efficiency of energy conversion device 12 and reformer 40.

Because exhaust from anode 20 may contain hydrogen, carbon monoxide, or other constituents, volume expansion engine 14 may be operated with an exceptionally lean mixture of fuel and air (e.g., a mixture having a low ratio of fuel to air), thereby reducing the emission of gaseous pollutants by volume expansion engine 14. In particular, the increased concentration of oxygen, nitrogen, and carbon dioxide within volume expansion engine 14 may lower the maximum combustion temperature within the combustion chamber of volume expansion engine 14. The lowered maximum combustion temperature may slow the chemical reaction of the combustion process, thereby decreasing the formation of nitrous oxides.

Because the exhaust from volume expansion engine 14 is redirected into cathode 22 of energy conversion device 12, the cost of power system 10 may be reduced and design flexibility thereof increased. Specifically, some fuel cell types, including MCFCs, require a supply of both carbon dioxide (CO₂) and oxygen (O₂), while other fuel cell types, including SOFCs, are tolerant of CO₂, but only require O₂. Because the exhaust from volume expansion engine 14 may contain a high concentration of CO₂, minimal or no additional supply components may be required when combining volume expansion engine 14 with an MCFC type of energy conversion device 12, as the supply of CO₂ already exists. In addition, because the exhaust flow from volume expansion engine 14 is routed directly into cathode 22, minimal or no heat exchanger hardware may be required to heat cathode 22. Further, because the SOFC type of energy conversion device 12 may be tolerant of CO₂, a power system 10 implementing the SOFC may have substantially the same hardware configuration as the power system 10 implementing the MCFC type of energy conversion device 12, without considerable negative effect. The reduced componentry may lower the cost of power system 10, while commonality between different power systems may increase design flexibility.

It will be apparent to those skilled in the art that various modifications and variations can be made to the power system of the present disclosure without departing from the scope of the disclosure. Other embodiments will be apparent to those skilled in the art from consideration of the specification and practice of the power system disclosed herein. For example, it is contemplated that volume expansion engine 14 may operate on low-sulfur oil to reduce or even eliminate the presence of sulfur compounds in fluid passageway 54. These sulfur compounds could potentially damage energy conversion device 12. It is intended that the specification and examples be considered as exemplary only, with a true scope of the disclosure being indicated by the following claims and their equivalents.

1. A power system, comprising:
an energy conversion device configured to:
receive fuel;
implement an electro-chemical process to generate an electrical output; and
produce a first exhaust flow;
a volume expansion engine configured to:
receive the first exhaust flow;
combust the first exhaust flow to generate a power output; and
as a byproduct of combustion, produce a second exhaust flow directed into the energy conversion device;
a supplemental source of fuel in communication with the volume expansion engine; and
a mixing device configured to mix fuel from the supplemental source of fuel with the first exhaust flow before the first exhaust flow is received by the volume expansion engine.

2. (canceled)

3. (canceled)

4. The power system of claim 1, further including at least one catalyst device located to condition the second exhaust flow before the second exhaust flow enters the energy conversion device.

5. The power system of claim 4, wherein the at least one catalyst device includes a Selective Catalytic Reduction device.

6. The power system of claim 4, wherein the at least one catalyst device includes an oxidation device.

7. The power system of claim 1, further including a reformer configured to condition the fuel.

8. The power system of claim 7, wherein heat resulting from the electro-chemical process is directed to the reformer.

9. The power system of claim 7, wherein the reformer is further configured to receive water.

10. The power system of claim 1, wherein air is mixed with the second exhaust flow to produce an air/exhaust mixture prior to the second exhaust flow entering the energy conversion device.

11. The power system of claim 10, further including a blower mechanism configured to regulate the temperature of the air/exhaust mixture.

12. The power system of claim 1, wherein the energy conversion device includes a carbonate electrolyte.

13. The power system of claim 1, further including a heat exchanger configured to cool the first exhaust flow before it is received by the volume expansion engine.

14. (canceled)

15. (canceled)

16. (canceled)

17. (canceled)

18. (canceled)

19. (canceled)

20. (canceled)

21. The power system of claim 1, further including a supply of air in fluid communication with the volume expansion engine, wherein the first exhaust flow is directed from an anode portion of the energy conversion device and is the only fluid flow directed from the energy conversion device to the volume expansion engine.

22. The power system of claim 1, wherein the volume expansion engine is a reciprocating piston engine.

23. The power system of claim 11, wherein the second exhaust flow is introduced to the energy conversion device at a location downstream of the blower mechanism.

24. A power system, comprising:
an energy conversion device having:
a fuel inlet;
an air inlet;
an electrical power outlet; and
an exhaust outlet;
a supplemental source of fuel;
a mixing device connected downstream of the exhaust outlet of the energy conversion device and of the supplemental source of fuel;
a volume expansion engine located downstream of the mixing device and having an exhaust outlet connected upstream of the air inlet of the energy conversion device; and
a blower having a pressurized air outlet in fluid communication with the exhaust outlet of the volume expansion engine at a location upstream of the air inlet of the energy conversion device.

25. The power system of claim 24, wherein the exhaust outlet of the energy conversion device is connected to an anode portion of the energy conversion device and is the only energy conversion device outlet in fluid communication with the volume expansion engine.

26. The power system of claim 24, wherein the volume expansion engine is a reciprocating piston engine.

27. The power system of claim 24, further including a selective catalytic reduction device located between the volume expansion engine and the energy conversion device.

28. A power system, comprising:
a reciprocating piston engine;
a fuel cell having:
a reformed fuel inlet;
an air inlet in communication with a supply of air and with an exhaust flow from the reciprocating piston engine;
an electrical power outlet; and
an exhaust outlet connecting a lean fuel/air mixture with the reciprocating piston engine;
a supplemental source of fuel; and
a mixing device located downstream of the supplemental source of fuel and of the exhaust outlet, and upstream of the reciprocating piston engine.

29. The power system of claim 28, wherein the exhaust outlet is connected to an anode portion of the fuel cell and is the only fuel cell outlet in fluid communication with the reciprocating piston engine.
